(19) United States
(12) Patent Application Publication
(10) Pub. No.: US 2026/0116051 A1
(43) Pub. Date: Apr. 30, 2026

(54) GLASS ARTICLE AND METHODS OF MAKING THE SAME

(71) Applicant: CORNING INCORPORATED, CORNING, NY (US)

(72) Inventors: Venkatesh Botu, Corning, NY (US); Karl William Koch, III, Elmira, NY (US); Jing Shao, Chino Hills, CA (US); James Andrew West, Painted Post, NY (US)

(21) Appl. No.: 19/120,564

(22) PCT Filed: Nov. 8, 2023
(86) PCT No.: PCT/US2023/036993

§ 371 Date: Apr. 11, 2025

Related U.S. Application Data
(60) Provisional application No. 63/426,852, filed on Nov. 21, 2022.

(51) Int. Cl. B32B 17/06

(52) U.S. Cl. CPC B32B 17/06

(57) ABSTRACT

Various aspects of the present disclosure relate to glass article. The glass article includes a first region having a first packing density. The glass article further includes a second region abutting the first region and having a second packing density that is different from the first packing density. The glass article is phase-separated between the first region and the second region.

### CROSS-REFERENCE TO RELATED APPLICATIONS

This application claims the benefit of priority under 35 U.S.C. § 119 of U.S. Provisional Application No. 63/426,852 filed Nov. 21, 2022, the content of which is incorporated herein by reference in its entirety.

### FIELD

This disclosure relates to glass articles, and more specifically to glass article with phase-separation between the two regions.

### BACKGROUND

Glass materials can have undesirable reflective properties. These undesirable properties can negatively impact a user's ability to see through the glass. It is therefore desirable to develop glass articles to minimize their negative reflective properties.

### BRIEF DESCRIPTION OF THE FIGURES

FIG. 1 is a schematic diagram of light reflected on a one-layer thin film coating.

FIG. 2 is a schematic diagram depicting light reflected on a one-layer thin film coating

FIG. 3 is a graph showing the minimum photopic reflectance (%) vs. packing density of a first region and a second region.

FIG. 4 are two graphs showing the sensitivity of the first region (top) and the second region (bottom) of a glass article.

FIG. 5 is a graph showing the minimum photopic reflectance (%) vs. optimized thicknesses of the first region of a glass article.

FIG. 6 is a graph showing the minimum photopic reflectance (%) vs. optimized thicknesses of the second region of a glass article.

FIG. 7 is a graph showing the minimum photopic reflectance (%) vs. product of packing density and layer thickness.

FIG. 8 are a series of graphs showing the tolerance of packing density and thickness variation on reflectance (%). Incident angle=0°.

FIG. 9 is a graph showing standard deviation from minimum R (%) vs. deviation of thickness and refractive index.

FIG. 10 is a graph showing the reflectance spectrum (%) at different incident angles using the optimum parameters in FIG. 5.

FIG. 11 is a graph showing photopic reflectance (%) vs. incident angle using the optimum parameters in FIG. 5.

FIG. 12 is a transmission electron microscope (TEM) image of the surface of laminated glass with ˜99% transmittance in the visible range. There are approximately two porous layers with 125 nm and 100 nm thickness, respectively.

### SUMMARY OF THE INVENTION

Various aspects of the present disclosure relate to phase-separated glass article. The glass article includes a first region having a first packing density. The glass article further includes a second region abutting the first region and having a second packing density that is different from the first packing density.

Various aspects of the present disclosure relate to a method of making a phase-separated glass article. The glass article includes a first region having a first packing density. The glass article further includes a second region abutting the first region and having a second packing density that is different from the first packing density. The method includes heating a glass article precursor to a temperature above a glass transition temperature of the glass article precursor. The method further includes contacting the heated glass article precursor with an etchant to form a plurality of pores. The method further includes contacting the etched glass article precursor with water to form the glass article.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “glass article” is used in its broadest sense to include any object made wholly or partly of glass. Glass articles include laminates of glass and non-glass materials, laminates of glass and crystalline materials, and glass-ceramics (including an amorphous phase and a crystalline phase). The glass articles may be transparent or opaque and can optionally include a colorant that provides a specific color.

Reflection of glass articles occurs at the two interfaces between air and glass. This often accounts for ˜8% of the light incident on the glass to be reflected at normal incidence. One way to mitigate this behavior is by using anti-reflection (AR) coatings on glass surfaces that reduce the intensity of the reflected light. Such coatings include either a single layer or a stack of multiple low and high index materials that work to destructively interfere different reflections from the stack. Building good anti-reflection coatings across the visible wavelength range or beyond, often requires multiple different coatings to be applied. Anti-glare (AG) methods on the other hand work by scattering the incoming light away from the specular directions. This is commonly achieved by patterning the surface by etching, textured coatings, or bulk scatterers.

However, depositing multi-layer coatings is costly, time consuming, and can be a challenging process to control. On the other hand, masking a glass and etching it to texture the surface becomes a costly process.

As demonstrated in the instant disclosure, one can achieve a combination of both anti-reflection and anti-glare properties by leveraging glasses that phase separate upon heat treatment followed by etching one of the phases, to get a porous coating.

Glass articles capable of achieving the above mentioned anti-reflective and anti-glare properties are those that include a glass material that is capable of phase separating. Examples of such glass materials include a borosilicate glass. An example of a suitable borosilicate glass is a glass that includes from about 50 mol % to about 70 mol % SiO₂; about 5 mol % to about 15 mol % Al₂O₃; about 5 mol % to about 19 mol % B₂O₃; about 3 mol % to about 10 mol % CaO; about 0 mol % to about 7 mol % K₂O; about 1 mol % to about 10 mol % MgO, about 0.5 mol % to about 5 mol % SrO; and about 0.01 mol % to about 1 mol % SnO₂. An example of a suitable borosilicate glass is a glass that includes from about 60 mol % to about 65 mol % SiO₂; about 7 mol % to about 11 mol % Al₂O₃; about 9 mol % to about 17 mol % B₂O₃; about 5 mol % to about 9 mol % CaO; about 0 mol % to about 3 mol % K₂O; about 2 mol % to about 7 mol % MgO, about 1 mol % to about 3.5 mol % SrO; and about 0.06 mol % to about 0.08 mol % SnO₂. In some additional examples, the glass article can include lithium, sodium, or a mixture thereof.

The glass articles can be strengthened using any suitable method known in the art, including by including compressive stress (CS) into the glass article, that extends from a surface to a depth of compression (DOC); by utilizing a mismatch of the coefficient of thermal expansion between portions of the glass article to create a compressive stress region and a central region exhibiting a tensile stress; thermally by heating the glass article to a temperature above the glass transition point and then rapidly quenching; and chemically by ion exchange, where, e.g., ions at or near the surface of the glass article are replaced by, or exchanged with, larger ions having the same valence or oxidation state.

The thickness of the glass articles can be tailored to allow the glass article to be more flexible to achieve the desired radius of curvature. The thickness of the glass article can be substantially constant along its length. The glass article can have any suitable thickness, of about 0.2 mm to about 3 mm (e.g., about 0.2 mm to about 2 mm and about 0.4 mm to about 1.1 mm). Further, the glass article, once incorporated into glass constructions can have any suitable bending radius, or radius of curvature. The radius of curvature can be, for example, about 20 mm or greater, 40 mm or greater, 50 mm or greater, 60 mm or greater, 100 mm or greater, 250 mm or greater or 500 mm or greater. For example, the radius of curvature can be in a range from about 60 mm to about 1200 mm. Further still, the glass article can have any suitable width, e.g., in a range from about 5 cm to about 250 cm; and any suitable length, e.g., in a range from about 5 cm to about 250 cm.

As mentioned previously, the anti-reflective and anti-glare properties of the glass article is due to the packing densities in the glass article. Specifically, the glass article is designed to include at least two regions each with a different packing density. The first region and the second region abut each other and generally extend across the entire width of the glass article. A packing density of the first region is in a range of from about 10% to about 30%, about 15% to about 25%, less than, equal to, or greater than about 10%, 11, 12, 13, 14, 15, 16, 17, 18, 19, 20, 21, 22, 23, 24, 25, 26, 27, 28, 29, or about 30%. A packing density of the second region is in a range of from about 20% to about 40%, about 25% to 35%, less than, equal to, or greater than about 20%, 21, 22, 23, 24, 25, 26, 27, 28, 29, 30, 31, 32, 33, 34, 35, 36, 37, 38, 39, or about 40%. In some aspects the packing density of the first region is less than the packing density of the second region.

The packing density of the respective first and second regions is a measurement of the porosity of the respective regions. For example, if the first region has a packing density of 20%, that means that 20% of the total volume of the first region is porous and therefore filled with air. The pores of the first region and the second region are through pores. The through pores can independently have a width in a range of from about 10 nm to about 50 nm, about 20 nm to about 40 nm, less than, equal to, or greater than about 10 nm, 15, 20, 25, 30, 35, 40, 45, or about 50 nm.

The difference in the packing densities of the first region and second region creates a gradient of the refractive indices in the glass article. A refractive index of the first region is in a range of from about 1 to about 1.5, about 1.05 to about 1.2, less than, equal to, or greater than about 1, 1.1, 1.2, 1.3, 1.4, or about 1.5. A refractive index of the second region is in a range of from about 1.1 to about 1.6, about 1.2 to about 1.4, less than, equal to, or greater than about 1.1, 1.2, 1.3, 1.4, 1.5, or about 1.6 The glass article is designed such that a refractive index of the first region is less than a refractive index of the second region.

Bringing the refractive index to a value close to 1 helps to reduce the reflection of light impacting the glass article. The gradient created by the first region and the second region further helps to reduce the reflection of light impacting the glass article.

The first region forms an external surface of the glass article. A surface roughness of the first region can range from about 5 nm to about 15 nm, about 7 nm to about 9 nm, less than, equal to, or greater than about. As described further herein, the surface roughness in the first region can be formed by contacting the first region with an etchant. The projections, peaks, and/or valleys that are attributable to the surface roughness can conform to a predetermined pattern or a random pattern. The surface roughness imparted to the glass article helps to increase the antiglare properties of the glass article. Thus the combination of the gradient of refractive indices of the first region and second region along with the surface roughness of the first region together provide a glass article that is able to demonstrate good anti-reflective and anti-glare properties. As described further herein, the methods associated with forming the glass article a facile and relatively inexpensive, thus adding to the advantageous nature of the present disclosure.

As stated herein above, the glass material is one that is able to phase separate. This results in the glass article having a heterogenous distribution of constituents about the first and second region. For example the first region can be silicate rich and the second region can be boron rich.

The glass article of the instant disclosure, can be formed by heating a glass article precursor to a temperature above its glass transition temperature. The glass article precursor refers to the non-phase-separated glass article. The exact temperature that the glass article precursor will be heated to will depend on the glass article precursor itself. However, as non-limiting examples, the glass article precursor can be heated to a temperature in a range of from about 307° C. to about 1000° C., about 650° C. to about 900° C., less than, equal to, or greater than about 307, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or about 1000° C. Heating can last for an amount of time ranging from about 0.1 hours to about 10 hours, about 0.5 hours to about 8 hours, less than, equal to, or greater than about 0.1 hours, 0.5, 1, 1.5, 2, 2.5, 3, 3.5, 4, 4.5, 5, 5.5, 6, 6.5, 7, 7.5, 8, 8.5, 9, 9.5, or about 10 hours. Heating can occur in one step or in multiple steps.

Following heating, the surface of the first region is exposed to an etchant. The etchant is a chemical etchant. Examples of suitable etchants include an organic acid, an inorganic acid, or a mixture thereof. Examples of organic acids include citrate or an acetate. Examples of inorganic acids include HF, HNO₃, or H₂SO₄. The acid can be buffered, if desired. The etchant and the glass article can be contacted in any suitable manner. For example, regions of the glass article that are not desired to be etched can be protected with a mask. The mask can be formed of a material that is resistant or chemically inert to the etchant. Alternatively, the surface of the first region can be selective contacted with the etchant. In some further examples, a mask with a plurality of openings can be disposed over the surface of the first region such that the etchant only interacts with desired portions of the first region. The glass article can be continuously contacted with the etchant. Alternatively, the etchant can be intermittently contacted with the glass article. Etching can occur for an amount of time in a range of form about 0.5 minutes to about 30 minutes, about 1 minute to about 15 minutes, less than, equal to, or greater than about 0.5 minutes, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or about 15 minutes. The longer the glass article is exposed to the etchant, the deeper into the surface of the first region the etchant will penetrate.

The glass article can be a monolithic article of glass. In other examples, the glass article can be part of a glass laminate. For example the glass article can be put into direct contact with a glass article that differs in chemical composition from the glass article. The glass article may not have the same anti-reflective properties, anti-glare properties, or both, of the glass article. Thus the glass article can be used to provide beneficial properties to an existing glass article. A further potential benefit to including the glass article in a laminate structure is that phase separation only occurs on the comparatively thin glass article, which has less impact on the optical performance of the existing glass article, if those properties are desirable.

### Examples

In this disclosure, a two-layer surface treatment model is developed to approximate the porous surface of the glass, which reduces the reflectance of glass surface significantly. The reflection from the glass can be optimized by adjusting the refractive index (packing density) and thickness of the two layers. The model is based on theoretical derivation on the reflectance of a two-layer AR coating as a function of the packing density (PD) and thickness of each layer. The AR properties of the coatings can further be improved by controlling the experimental factors (heat treatment time/temperature and the etching conditions) that govern the packing density and thickness of the porous coating layers. By leveraging the models we undertake an optimization study by exploring the parameter space of packing density and thickness to obtain the lowest reflectance per surface.

### Theoretical Calculation and Modeling of Two-Laver Surface Treatment

The calculation of a two-layer coating is based on multiple interference between reflected and transmitted light in the thin film stack. Since the refractive index of the porous layer is between glass and air, it is determined by the packing density

$$n = PD \times {n}_{glass} + ( 1 - PD ) \times {n}_{air} . \qquad ( 1 )$$

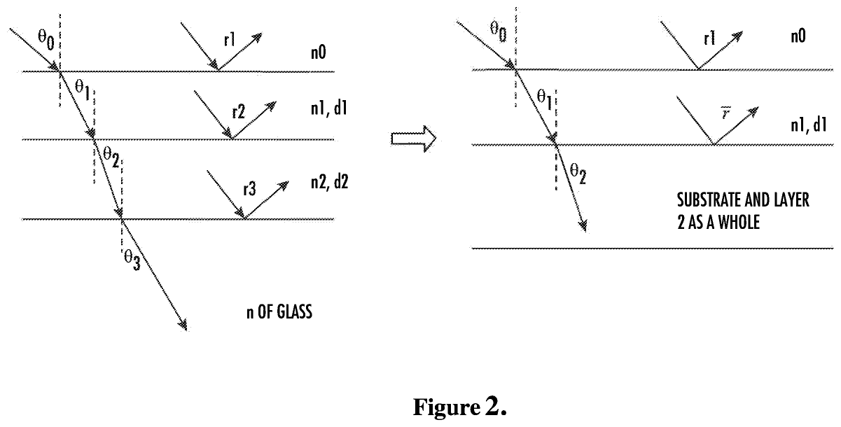

The theoretical calculation of reflectance of a two-layer coating can be found in classic optical physics books. For the completeness of the disclosure, they are included here. With respect to the first layer (or first region) as shown in FIG. 2, when the light is launched into the coating, a portion of the light is transmitted into the medium and the remaining portion (e.g., second portion or second region) is reflected, material absorption is neglected. The transmitted light can also be reflected or transmitted, so the total reflected light is the interference of reflected light 1, 2, 3, 4 and etc. Assume θ₁ is the incident angle, θ₂ is the refracted angle, r₁ and r₂ are the reflection coefficients on the top and bottom surface of the coating. If the refractive index of the medium of the incident light is n₁ and the refractive index of the coating is n₂, and the coating thickness is d₂. The effective amplitude reflection coefficient of a single layer thin film is

$$\overline{r} = \begin{matrix}{A}^{( r )} \\ {A}^{( i )}\end{matrix} = \text{?} + {\text{?}}^{i δ} \text{?} + {\text{?}}^{δ} + {\text{?}}^{δ} + \text{?} = \frac{{r}_{1} + {r}_{2} {e}^{i δ}}{1 + {r}_{1} {r}_{2} {e}^{i δ}} \\ where δ = \begin{matrix}4 π \\ λ\end{matrix} \text{?} \qquad ( 2 )$$

$$\text{?} \text{indicates text missing or illegible when filed}$$

θ₂, and ω is the light frequency. The term exp(−iωt) can be ignored while we calculated the light intensity.

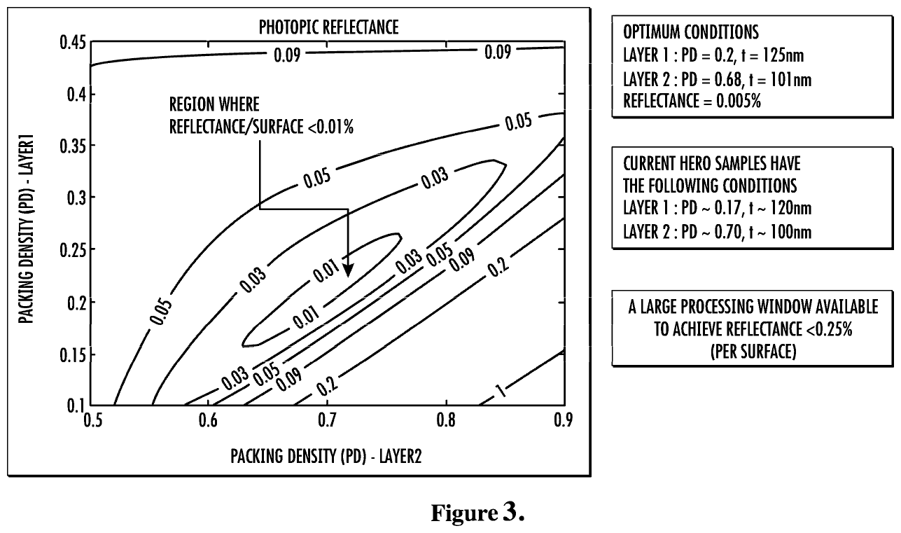

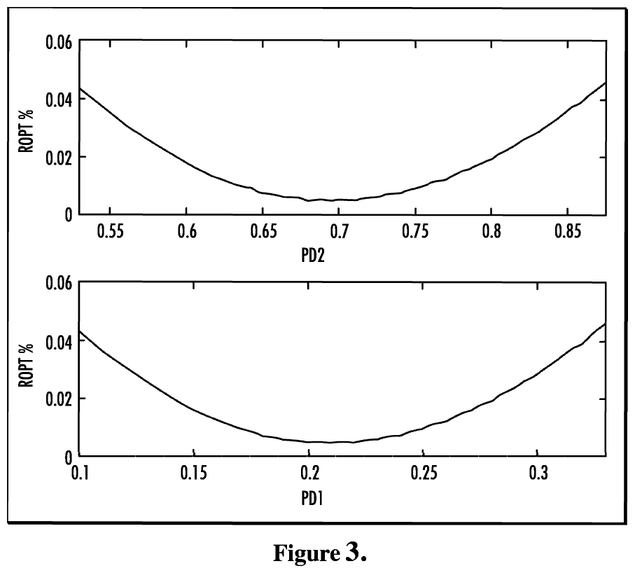

Next light reflected on two-layer film is examined, as shown in FIG. 3. n₀, n₁, n₂ and n are the refractive index of air, layer 1, and layer 2 and article, respectively. Here, glass is used as the article. At first, the effective reflection coefficient r̅ of layer 2 and the article together can be written using Equation 2

$$\overline{r} = \frac{{r}_{2} + {r}_{3} {e}^{i {δ}_{2}}}{1 + {r}_{2} {r}_{3} {e}^{i {δ}_{2}}} where {δ}_{\text{?}} = \begin{matrix}4 π \\ λ\end{matrix} \text{?} \qquad ( 3 )$$

$$\text{?} \text{indicates text missing or illegible when filed}$$

θ₂. Then the total reflection coefficient of the two-layer film is

$$r = \frac{{r}_{1} + \overline{r} {e}^{i {δ}_{1}}}{1 + {r}_{1} \overline{r} {e}^{i {δ}_{1}}} where {δ}_{\text{?}} = \begin{matrix}4 π \\ λ\end{matrix} \text{?} \qquad ( 4 )$$

$$\text{?} \text{indicates text missing or illegible when filed}$$

θ₁. Now the intensity reflectance is

$$R ( λ ) = \text{?} \cdot {r}^{*} , \qquad ( 5 )$$

$$\text{?} \text{indicates text missing or illegible when filed}$$

where the asterisk denotes the complex conjugate of the amplitude reflection coefficient. And the photopic reflectance is calculated by

$$Y = \frac{{\int }_{400}^{700} R ( λ \text{?} \text{?} λ \text{?} \text{?} λ \text{?} λ}{{\int }_{400}^{700} I ( λ \text{?} \text{?} λ \text{?} λ} \qquad ( 6 )$$

$$\text{?} \text{indicates text missing or illegible when filed}$$

where I(λ) is the source spectrum and we use D65 source, and y(λ) is the color matching function. From Equation 6, we see that photopic reflectance of a two-layer coating is a function of coating parameters. Therefore, we can scan and optimize the layer parameters. We built a model to calculate and optimize the porous layer parameters based on this calculation.

### Optimization of Simulation Results and Tolerance Analysis

To find the minimum photopic reflectance of a two-layer coating, the packing density of the two layers, PD1 and PD2, is studied. For every combination of PD1 and PD2, reflectance is minimized, by adjusting the thickness of the two layers. FIG. 4 gives the calculated minimum averaged photopic reflectance as a function of PD1 and PD2. The averaged photopic reflectance is calculated by averaging the reflectance when the incident angle is 0°, 10°, 20° and 30°. The minimum averaged photopic reflectance is 0.0049% when PD1=0.2 and PD2=0.68, and the optimum thicknesses of the two layers are 125.2 nm and 101 nm, respectively. Also, there is a region with low reflectance in FIG. 4, in which PD1 linearly increases with PD2 with slope ˜⅔. This is a good information for processing and we can easily increase or decrease packing density of both layers.

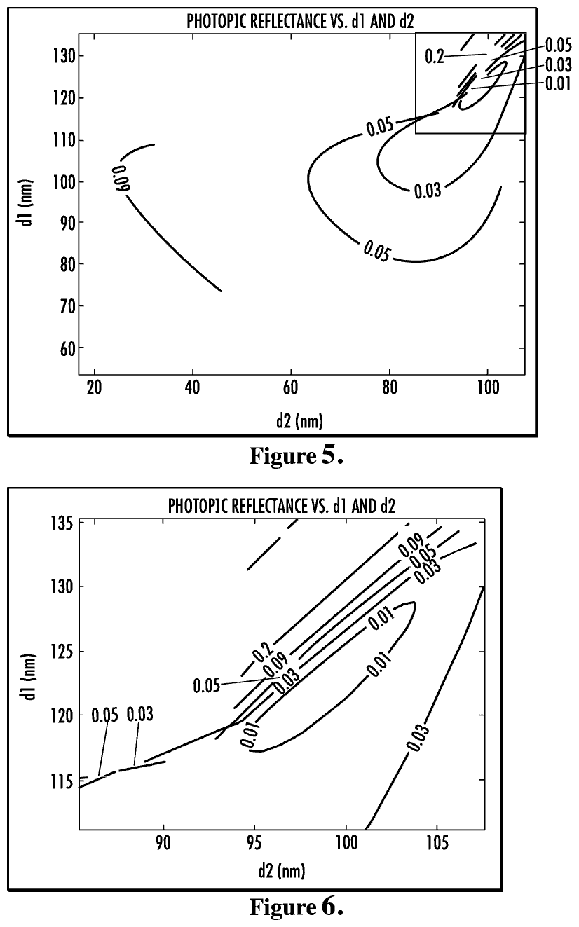

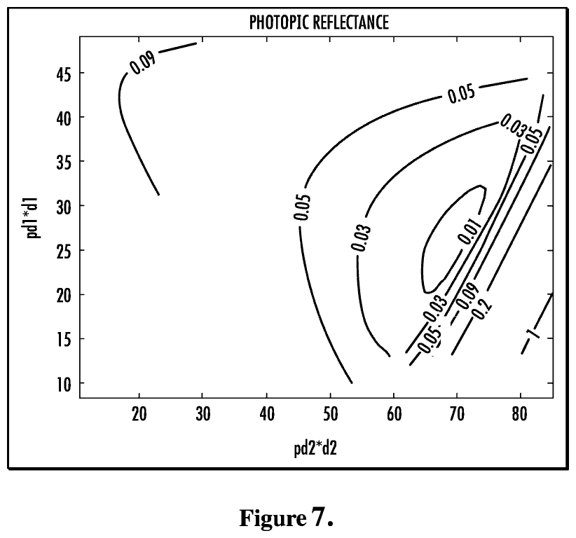

This model can also be applied to analyze the tolerance of the layer parameters. FIG. 5 plots photopic reflectance vs. PD1 and PD2 on the yellow line in FIG. 4. It is seen that reflectance smaller than 0.04% can be achieved in a range when PD1 is between 0.1 and 0.3, and PD2 is between 0.55 to 0.85 as long as PD1 linearly changes with PD2. FIG. 6 plots photopic reflectance vs. optimum layer thicknesses when we scan the packing density combination in FIG. 4. FIG. 7 gives photopic reflectance vs. the product of packing density and layer thickness. FIGS. 6 and 7 provide the information of how the reflectance changes with layer thickness and optical path length, and the blue areas indicate the tolerance of layer thicknesses and optical path length.

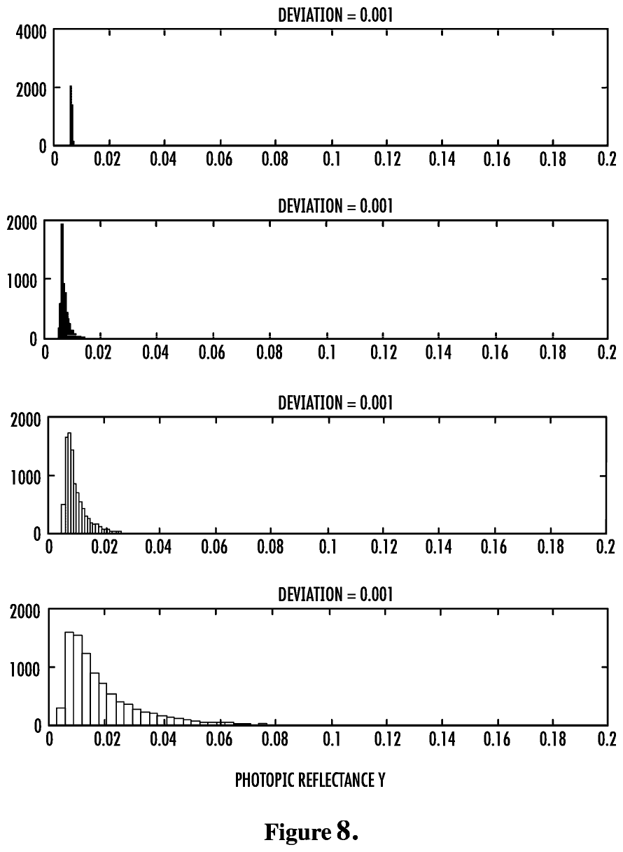

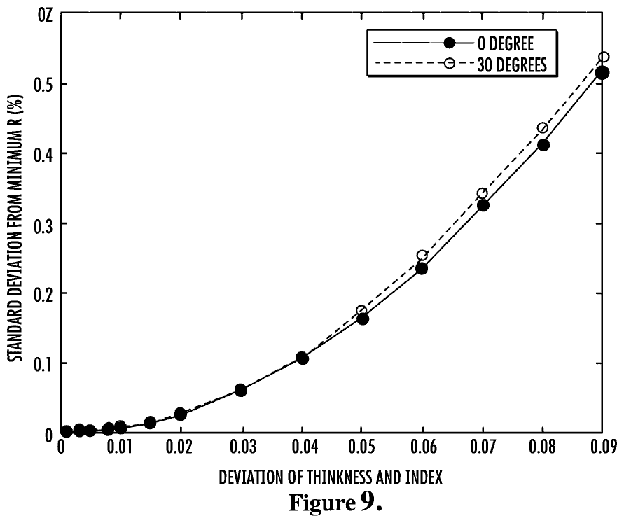

FIG. 8 shows the histograms of photopic reflectance when the layer parameters are deviated from the optimum point. The deviation is 0.001, 0.005, 0.01, and 0.02, respectively. X axis is the photopic reflectance (Y), and the width of the histogram increases with the parameters deviation, which gives us the criteria to analyze the layer parameters tolerance. Standard deviations away from minimum reflectance as a function of deviation of thicknesses and refractive index are plotted in FIG. 9, when the incident angle is 0° and 30°, respectively. If the layer parameters has deviation 0.09, the standard deviation away from minimum reflectance is about 0.53%. Therefore, the model builds a tolerance estimation of reflectance on layer parameters.

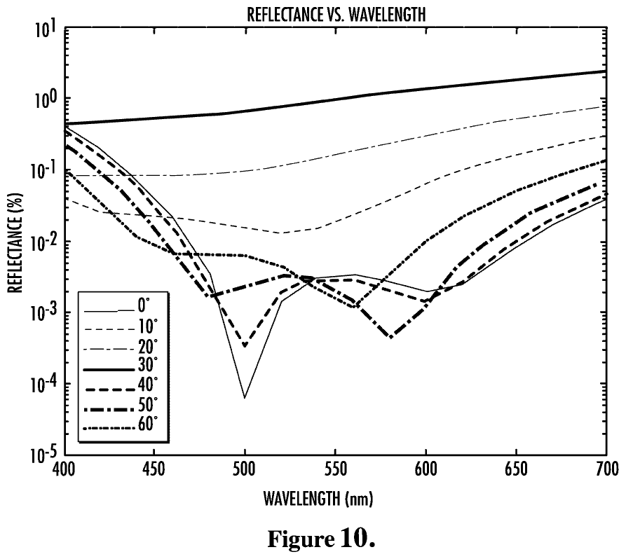

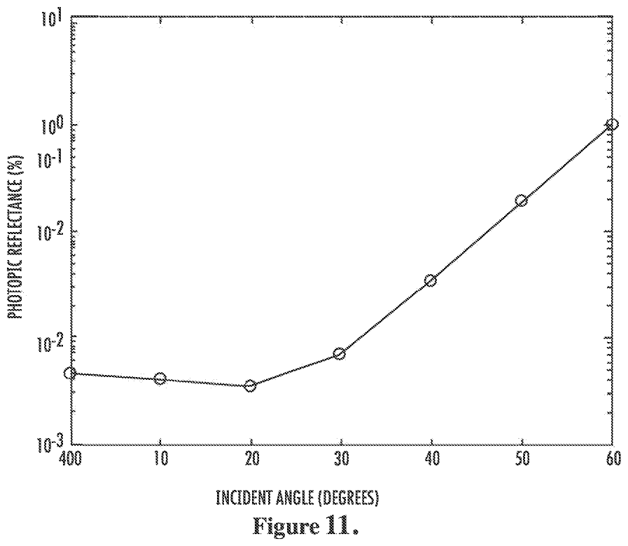

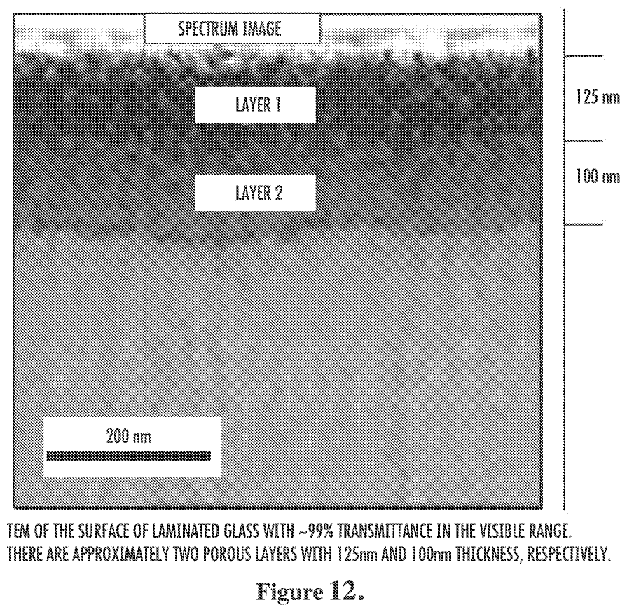

Reflectance is also considered as a function of incident angle when the optimal layer thickness and packing density for small incident angles are used. FIG. 10 shows the reflected spectrum when the incident angle is from 0° to 60°. As can be seen, reflectance increases as incident angle. Photopic reflectance vs. indicent angle is plotted in FIG. 11 and the same conclusion can be drawn. When the incident angle is 60°, a still very low photopic reflectance of ˜1% can be achieved.

### Optimizing Color of Reflected Surface Treatments

For several of the design parameters those that would result in varying color and reflectance properties are considered. Below are 3 such designs that trade-off between the 2 properties.
Design 1: Rx=0.13%, Good color in reflection

| | Index | Thickness (um) |
|---|---|---|
| n0 | 1 | |
| n1 | 1.163 | 0.124 |
| n2 | 1.372 | 0.130 |
| ns | 1.51 | |

Design 2: Rx=0.003%, Strong color in reflection at high angles

| | Index | Thickness (um) |
|---|---|---|
| n0 | 1 | |
| n1 | 1.1122 | 0.124 |
| n2 | 1.3621 | 0.1 |
| ns | 1.51 | |

Design 3: Rx=0.767%, Excellent stable color in reflection

| | Index | Thickness (um) |
|---|---|---|
| n0 | 1 | |
| n1 | 1.28 | 0.116 |
| n2 | 1.442 | 0.096 |
| ns | 1.51 | |

### Application of the Model on Optimizing the Sample Reflectance

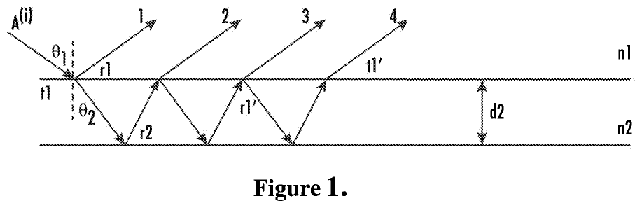

The optimized thicknesses of the two-layer coating in the model can be used to obtain the optimum porous layer thickness. The optimized refractive index can be realized by adjusting the packing density of the porous layer. Both the porous layer thickness and packing density can be optimized by controlling the heating and etching conditions. FIG. 11 is one of the samples that has the lowest reflectance obtained experimental thus far. The thickness of the two layers are 125 nm and 100 nm, respectively. It matches very well with the modeled results 125.2 nm and 101 nm, respectively. Also, the packing density shown in FIG. 1 is about 20% and 70% for layer 1 and layer 2, respectively.

### Exemplary Aspects

The following exemplary aspects are provided, the numbering of which is not to be construed as designating levels of importance:

Aspect 1 provides a phase-separated glass article comprising:
a first region comprising a first packing density;
a second region abutting the first region and having a second packing density that is different from the first packing density, wherein:
the glass article is phase-separated between the first region and the second region.

Aspect 2 provides the phase-separated glass article of Aspect 1, wherein the first packing density is in a range of from about 10% to about 30%.

Aspect 3 provides the phase-separated glass article of any one of Aspects 1 or 2, wherein the first packing density is in a range of from about 15% to about 25%.

Aspect 4 provides the phase-separated glass article of any one of Aspects 1-3, wherein the second packing density is in a range of from about 20% to about 40%.

Aspect 5 provides the phase-separated glass article of any one of Aspects 1-4, wherein the second packing density is in a range of from about 25% to about 35%.

Aspect 6 provides the phase-separated glass article of any one of Aspects 1-5, wherein the first packing density is less than the second packing density.

Aspect 7 provides the phase-separated glass article of any one of Aspects 1-6, wherein a refractive index of the first region is in a range of from about 1 to about 1.5.

Aspect 8 provides the phase-separated glass article of any one of Aspects 1-7, wherein a refractive index of the first region is in a range of from about 1.05 to about 1.2.

Aspect 9 provides the phase-separated glass article of any one of Aspects 1-8, wherein a refractive index of the second region is in a range of from about 1.1 to about 1.6.

Aspect 10 provides the phase-separated glass article of any one of Aspects 1-9, wherein a refractive index of the first region is in a range of from about 1.2 to about 1.4.

Aspect 11 provides the phase-separated glass article of any one of Aspects 1-10, wherein a refractive index of the first region is less than a refractive index of the second region.

Aspect 12 provides the phase-separated glass article of any one of Aspects 1-11, wherein the glass article comprises a borosilicate glass.

Aspect 13 provides the phase-separated glass article of any one of Aspects 1-12, wherein the glass article comprises a material that is capable of undergoing phase separation.

Aspect 14 provides the phase-separated glass article of any one of Aspects 1-13, wherein the glass article is a monolithic glass structure.

Aspect 15 provides the phase-separated glass article of any one of Aspects 1-14, wherein the glass article is a laminate disposed on a core material.

Aspect 16 provides the phase-separated glass article of Aspect 15, wherein the core material is a second glass article.

Aspect 17 provides the phase-separated glass article of any one of Aspects 1-16, wherein a thickness of the first region and the second region are independently in a range of from about 50 nm to about 200 nm.

Aspect 18 provides the phase-separated glass article of any one of Aspects 1-17, wherein a thickness of the first region and the second region are independently in a range of from about 100 nm to about 150 nm.

Aspect 19 provides the phase-separated glass article of any one of Aspects 1-18, wherein a surface roughness of a first major surface of the glass article is in a range of from about 5 nm to about 15 nm.

Aspect 20 provides the phase-separated glass article of any one of Aspects 1-19, wherein a surface roughness of a first major surface of the glass article is in a range of from about 7 nm to about 9 nm.

Aspect 21 provides the phase-separated glass article of any one of Aspects 1-20, wherein the glass article comprises a plurality of through pores.

Aspect 22 provides the phase-separated glass article of any one of Aspects 1-21, wherein the plurality of through pores independently have a width in a range of from about 10 nm to about 50 nm.

Aspect 23 provides the phase-separated glass article of any one of Aspects 1-22, wherein the plurality of through pores independently have a width in a range of from about 20 nm to about 40 nm.

Aspect 24 provides a method of making the phase-separated glass article of any one of Aspects 1-23, the method comprising:
heating a glass article precursor to a temperature above a glass transition temperature of the glass article precursor;
contacting the heated glass article precursor with an etchant to form a plurality of pores; and
contacting the etched glass article precursor with water to form the glass article.

Aspect 25 provides the method of Aspect 24, wherein the etchant comprises HF, HNO₃, a buffered acid, a citrate, an acetate, or a mixture thereof.

Aspect 26 provides the method of any one of Aspects 24 or 25, wherein the glass transition temperature is in a range of from about 650° C. to about 900° C.

Aspect 27 provides the method of any one of Aspects 24-26, wherein the glass transition temperature is in a range of from about 700° C. to about 800° C. includes a surfactant shell at least partially encasing the solid-lipid matrix core.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

1. A phase-separated glass article comprising:
a first region comprising a first packing density;
a second region abutting the first region and having a second packing density that is different from the first packing density, wherein:
the glass article is phase-separated between the first region and the second region.

2. The phase-separated glass article of claim 1, wherein the first packing density is in a range of from about 10% to about 30%.

3. (canceled)

4. The phase-separated glass article of claim 1, wherein the second packing density is in a range of from about 20% to about 40%.

5. (canceled)

6. The phase-separated glass article of claim 1, wherein the first packing density is less than the second packing density.

7. The phase-separated glass article of claim 1, wherein a refractive index of the first region is in a range of from about 1 to about 1.5.

8. (canceled)

9. The phase-separated glass article of claim 1, wherein a refractive index of the second region is in a range of from about 1.1 to about 1.6.

10. (canceled)

11. The phase-separated glass article of claim 1, wherein a refractive index of the first region is less than a refractive index of the second region.

12. The phase-separated glass article of claim 1, wherein the glass article comprises a borosilicate glass.

13. The phase-separated glass article of claim 1, wherein the glass article comprises a material that is capable of undergoing phase separation.

14. The phase-separated glass article of claim 1, wherein the glass article is a monolithic glass structure.

15. The phase-separated glass article of claim 1, wherein the glass article is a laminate disposed on a core material.

16. The phase-separated glass article of claim 15, wherein the core material is a second glass article.

17. The phase-separated glass article of claim 1, wherein a thickness of the first region and the second region are independently in a range of from about 50 nm to about 200 nm.

18. The phase-separated glass article of claim 1, wherein a thickness of the first region and the second region are independently in a range of from about 100 nm to about 150 nm.

19. The phase-separated glass article of claim 1, wherein a surface roughness of a first major surface of the glass article is in a range of from about 5 nm to about 15 nm.

20. (canceled)

21. The phase-separated glass article of claim 1, wherein the glass article comprises a plurality of through pores.

22. The phase-separated glass article of claim 21, wherein the plurality of through pores independently have a width in a range of from about 10 nm to about 50 nm.

23. (canceled)

24. A method of making the phase-separated glass article of claim 1, the method comprising:
heating a glass article precursor to a temperature above a glass transition temperature of the glass article precursor;
contacting the heated glass article precursor with an etchant to form a plurality of pores; and
contacting the etched glass article precursor with water to form the glass article.

25. The method of claim 24, wherein the etchant comprises HF, HNO₃, a buffered acid, a citrate, an acetate, or a mixture thereof.

26. The method of claim 24, wherein the glass transition temperature is in a range of from about 650° C. to about 900° C.

27. (canceled)
